(19) United States
(12) Patent Application Publication
(10) Pub. No.: US 2010/0014314 A1
(43) Pub. Date: Jan. 21, 2010

(54) LIGHT DIFFUSION PLATE, COMPOSITION LIQUID FOR FORMING A LIGHT DIFFUSION LAYER AND PROCESS FOR PRODUCING LIGHT DIFFUSION PLATE

(75) Inventors: Hisao Inokuma, Chiyoda-ku (JP); Satoru Takaki, Chiyoda-ku (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: ASAHI GLASS COMPANY, LIMITED, Chiyoda-ku (JP)

(21) Appl. No.: 12/503,877

(22) Filed: Jul. 16, 2009

Related U.S. Application Data
(63) Continuation of application No. PCT/JP2008/050908, filed on Jan. 23, 2008.

(30) Foreign Application Priority Data
Jan. 23, 2007 (JP) 2007-012677

(51) Int. Cl. F21V 7/04; C08L 67/00; B05D 5/06

(52) U.S. Cl. 362/608; 524/599; 427/165

(57) ABSTRACT

A conventional light diffusion plate provided in a direct type backlight unit to be employed for e.g. a liquid crystal display, has problems in that it does not have a sufficient diffusion performance, it is difficult to increase the size, and it is difficult to produce such a light diffusion plate at low cost.

A light diffusion plate comprising a glass substrate and a light diffusion layer formed on the glass substrate, wherein the light diffusion layer comprises a matrix and a light diffusion agent, the absolute value Δn of the refractive index difference between the matrix and the light diffusion agent is 0.05 or more and less than 0.5, and the volume ratio of the light diffusion agent in the light diffusion layer is 30% or more.

### TECHNICAL FIELD

The present invention relates to a light diffusion plate for a direct type backlight unit to be employed for e.g. a liquid crystal display, and to a coating liquid for forming a light diffusion layer that is employed for production of such a light diffusion plate.

### BACKGROUND ART

Liquid crystal displays are employed for monitors of personal computers, home-use TVs, cell phones, etc. In recent years, along with an increase in demand for such liquid crystal displays for home-use TVs, a rapid increase in the display size is in progress. Backlight units for providing light to liquid crystal TVs are of a side light type and a direct type. For the application to home-use TVs requiring a large display size and a high brightness, backlight units of a direct type are mainly employed.

A direct type backlight unit usually has, as shown in FIG. 4, a light source 5; a light diffusion plate 1 disposed on a front side of the light source for erasing a light source image of the light source so as to make the brightness uniform; a diffusion film 2 and a prism sheet 3 for focusing the light, that is spread by the light diffusion plate, on a front face; a brightness-improving film 4 for aligning the polarization direction of the light from the light source and obtaining a higher brightness; and a reflective plate 6 provided on the backside of the light source 5 and reflecting light from the light source 5. Here, symbol 7 indicates a liquid crystal panel, and the liquid crystal panel will be defined as not being included in a backlight unit.

The light diffusion plate is usually produced by extrusion-molding into a plate shape a resin such as an acrylic resin, a polycarbonate resin or an acrylic-styrene copolymer resin, which is kneaded in advance with at least one type of light diffusion agent such as powder glass, fine pulverized glass fibers, titanium dioxide, calcium carbonate, silicon dioxide, aluminum oxide, inorganic fine powder, PMMA, a polystyrene or an acrylic-styrene copolymer resin.

However, it is difficult for the above diffusion plate having a resin substrate to achieve high brightness with a large size or a small thickness for the following reasons.

First of all, a large sized diffusion plate tends to warp or deflect, which causes uneven brightness in a display screen. To solve this problem, it is necessary to increase the thickness of the substrate, which prevents the reduction of the thickness of a backlight unit and increases the cost.

Further, in order to increase the size of the diffusion plate, it is necessary to use many light sources and to increase the brightness, which increases the emission of heat and UV rays from the light sources. This tends to cause thermal deformation or yellowing of the diffusion plate, or warp of the diffusion plate due to emission of moisture absorbed in the diffusion plate. In order to solve these problems, it is necessary to increase the distance from the light sources to the diffusion plate, which increases the thickness of the device and prevents thickness reduction of the device and decreases the brightness.

In order to solve the above problems of conventional resin diffusion plates, a diffusion plate employing a glass substrate is proposed.

Patent Document 1 shows a diffusion plate constituted by a glass coated with a light diffusion agent, and discloses organic and inorganic coating materials and pigments as the components of the light diffusion agent, but there is no specific description in the document as to the construction or the properties of a light diffusion layer formed by the light diffusion agent.

Further, Patent Document 2 shows a diffusion plate made of a glass, which has a haze value of 95% or more and a transmittance of from 10 to 40%, but the document does not describe as to the specific construction of the diffusion plate other than the optical properties of the diffusion plate. Further, since its transmittance is only from 10 to 40%, the brightness of a backlight unit employing the diffusion plate will be insufficient.

Patent Document 3 shows a diffusion plate comprising a glass substrate and a diffusion film pasted on the glass substrate, and a diffusion plate comprising a glass having a surface with irregularities formed by sandblast. In a step of pasting the film, when the film has a large area, it is difficult to prevent mixing of bubbles or foreign matter, which increases the cost. Further, with respect to the diffusion plate having a pasted film, the document does not describe the specific construction and the optical properties of the film or the diffusion plate. Further, with respect to the diffusion plate comprising a glass having a surface with irregularities, light diffusion occurs only at the glass surface and its diffusion performance is inherently limited. Further, it is difficult to produce fine irregularities by sandblast, and fine unevenness of brightness may occur on a screen.

Patent Document 4 shows a construction comprising a glass substrate and a light diffusion layer formed on the glass substrate by means of screen printing, and the light diffusion layer contains from 15 to 35 mass % of spherical beads having an average particle size of from 5 to 40 μm, and has a thickness of from 5 to 100 μm. However, according to Examples 1 and 2 of the document, the diffusion layer is formed by carrying out coating twice, which may require a long production time and cause a problem of the cost. Further, Example 3 shows a diffusion layer formed by carrying out coating once, but since it employs a white pigment, the total light transmittance becomes low and the brightness of a backlight unit employing the light diffusion layer becomes low.

Patent Document 1: JP-A-4-350821

Patent Document 2: JP-A-2004-127643

Patent Document 3: JP-A-2005-129346

Patent Document 4: JP-A-2006-162846

### DISCLOSURE OF THE INVENTION

### Problems to be Solved by the Invention

As described above, with respect to a light diffusion plate for a direct type backlight unit, which employs a glass as a substrate, prior art documents have not sufficiently shown the specific construction, its requirement for high transmission and uniform diffusion property as the optical properties, and a method for producing it at low cost.

Under the circumstances, it is an object of the present invention to provide a light diffusion plate having high transmittance and a sufficient diffusion property for a direct type backlight unit, which has a high rigidity and undergoes no heat deformation or yellowing, and thus, which is ready for an increase in the size. Further, it is another object of the present invention to provide such a light diffusion plate and a direct type backlight unit employing such a light diffusion plate. Further, it is another object of the present invention to provide a coating liquid for forming a light diffusion layer, which can form a layer exhibiting a required performance by a single coating operation with the solution. Further, it is another object of the present invention to provide a process for producing the light diffusion plate.

### Means for Solving the Problems

In conventional resin diffusion plates, a diffusion agent is distributed in the entire thickness (a few mm) of a substrate, while the light diffusion layer of the present invention has a thin thickness of from 5 to 100 μm. For this reason, it is necessary to increase the diffusion performance per a unit thickness. Accordingly, the light diffusion agent contributing to the diffusion performance preferably has a large volume ratio in the layer and a large refractive index difference. However, if the refractive index difference is too large, unnecessary diffusion increases and the brightness of a backlight unit employing the diffusion plate decreases, which is not preferred.

The present inventors have conducted extensive studies to achieve the above objects, and as a result, they have discovered that in a light diffusion plate comprising a glass substrate and a light diffusion layer formed on the glass substrate, when the absolute value Δn of the refractive index difference between the matrix and a light diffusion agent of the light diffusion layer, and the volume ratio of the light diffusion agent in the light diffusion layer, are controlled so that the absolute value Δn of the refractive index difference between the matrix and the light diffusion agent becomes 0.05 or more and less than 0.5, and that the volume ratio of the light diffusion agent in the light diffusion layer becomes 30% or more, then, it is possible to obtain a light diffusion plate having sufficient diffusion performance as a diffusion plate for direct type backlight unit and producible at low cost, and based on this knowledge, they completed the present invention.

The present invention provides the following items (1) to (9).

(1) A light diffusion plate comprising a glass substrate and a light diffusion layer formed on the glass substrate, wherein the light diffusion layer comprises a matrix and a light diffusion agent, the absolute value Δn of the refractive index difference between the matrix and the light diffusion agent is 0.05 or more and less than 0.5, and the volume ratio of the light diffusion agent in the light diffusion layer is 30% or more.

(2) The light diffusion plate according to the above (1), wherein the thickness of the light diffusion layer is from 5 to 100 μm.

(3) The light diffusion plate according to the above (1) or (2), wherein the matrix contains an urethane type resin.

(4) The light diffusion plate according to any one of the above (1) to (3), wherein the glass substrate is made of a soda lime silicate glass.

(5) A direct type backlight unit employing the light diffusion plate as defined in any one of the above (1) to (4).

(6) The direct type backlight unit according to the above (5), wherein the brightness of the front side of the direct type backlight unit is 9,500 cd/m² or more.

(7) A coating liquid for forming a light diffusion layer containing a matrix-forming component and a light diffusion agent, wherein the absolute value Δn of the refractive index difference between a matrix formed from the matrix-forming component and the light diffusion agent is 0.05 or more and less than 0.5, and the matrix-forming component is a polyester polyol type resin having an average molecular weight of from 1,000 to 9,000, and an volume fraction in the liquid of the light diffusion agent defined by the following formula is 30% or more:

$$Volume fraction in the liquid ( \% ) = \frac{[ \frac{Mass content of light diffusion agent in coating liquid}{Specific gravity of light diffusion agent} ]}{\begin{matrix}[ \frac{Mass content of light diffusion agent in coating}{Specific gravity of light diffusion agent} ] + \\ [ \frac{Mass content of matrix in coating}{Specific gravity of matrix} ]\end{matrix}} \times 100$$

(8) The coating liquid for forming a light diffusion layer according to the above (7) which contains an isocyanate type curing agent.

(9) A process for producing a light diffusion plate having a glass substrate and a light diffusion layer formed on the glass substrate, which comprises a coating step of coating the glass substrate with the coating liquid for forming a light diffusion layer as defined in the above (7) or (8) so as to form a coating film, and a forming step of drying and curing the coating film to form the light diffusion layer.

### EFFECTS OF THE INVENTION

In the light diffusion layer of the present invention, since the absolute value Δn of the refractive index difference between the matrix and the light diffusion agent constituting the light diffusion layer is 0.05 or more and less than 0.5 and the volume ratio of the light diffusion agent in the light diffusion layer is 30% or more, it is possible to achieve both high transmittance and sufficient diffusion property.

Further, since the substrate is made of a glass, unlike a diffusion plate made of a resin, there occurs no warp, yellowing or thermal deformation due to heat of e.g. light sources, and there occurs no warp due to absorption of moisture. Accordingly, even when the light sources and the diffusion plate are disposed closely to each other, the light emission quality of a backlight unit is not deteriorated. Further, since the light diffusion plate has a high rigidity, it does not warp even when it has a large size. Accordingly, the light diffusion plate of the present invention is suitable for size-increase or thickness-reduction of backlight units.

Further, the coating liquid of the present invention can exhibit desired diffusion properties even when the light diffusion layer has a small thickness of from 5 to 100 μm. Further, since the light diffusion layer can exhibit the diffusion properties even when the light diffusion layer has a small thickness of from 5 to 100 μm, it can be produced by a single coating operation with the coating liquid, and the coating liquid has an excellent economical efficiency.

### BRIEF DESCRIPTION OF THE DRAWINGS

FIG. 1 is a side cross-sectional view schematically showing a light diffusion plate according to the present invention.

FIG. 2 is a side cross-sectional view of a preferred embodiment of a liquid crystal panel combined with a backlight unit of the present invention.

FIG. 3 is a side cross-sectional view of an embodiment of the backlight unit employing the light diffusion plate of the present invention.

FIG. 4 is a side cross-sectional view of a liquid crystal panel employing a conventional backlight unit.

### EXPLANATION OF NUMERALS

1: (Conventional) light diffusion plate
1a: Light diffusion plate of the present invention
2: Diffusion film
3: Prism sheet
4: Brightness-improving film
5: Light source
6: Reflective plate
7: Liquid crystal panel
100: Glass substrate
110: Light diffusion layer

### BEST MODE FOR CARRYING OUT THE INVENTION

Now, the present invention will be described in detail.

The light diffusion plate for a direct type backlight unit of the present invention is a light diffusion plate for a direct type backlight unit, comprising a glass substrate and a light diffusion layer formed on the glass substrate.

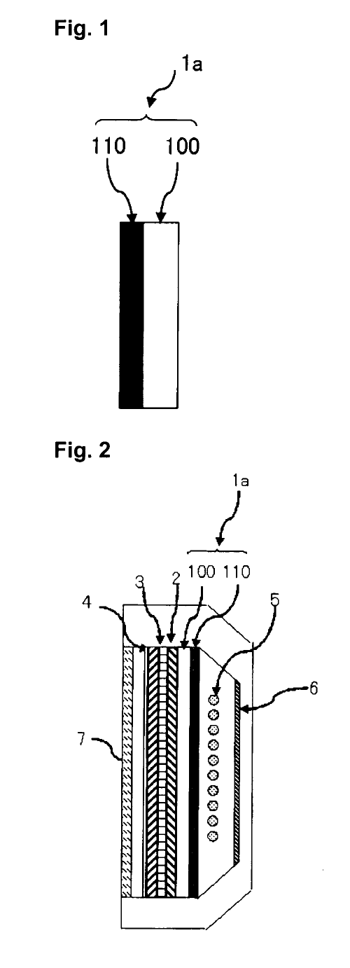

Next, the glass substrate, the light diffusion layer formed on the glass substrate and the light diffusion plate for a direct type backlight unit of the present invention will be described in detail. FIG. 1 is a side cross-sectional view schematically showing a light diffusion plate according to the present invention. As shown in FIG. 1, the light diffusion plate 1a comprises a glass substrate 100 and a light diffusion layer 110 formed on a surface 100. Here, the diffusion layer 110 may be formed on one surface or each surface of the substrate 100.

The glass substrate is not particularly limited, and it may, for example, be a transparent glass plate made of a colorless and clear soda lime silicate glass, an aluminosilicate glass, a borate glass, a lithium aluminosilicate glass, a quartz glass, a borosilicate glass substrate, a non-alkaline glass substrate or other type of glasses.

Among these, from the viewpoint of employing the light diffusion plate of the present invention for direct type backlight units, it is preferably a soda lime silicate glass.

Further, the thickness of the glass substrate depends on e.g. the size of a direct type backlight unit employing the light diffusion plate of the present invention, but it is preferably from 1.5 to 4.5 mm, more preferably from 1.5 to 2.5 mm.

Further, the glass substrate preferably has a transmittance of 90% or more in the entire wavelength region of from 380 nm to 800 nm in order to obtain higher brightness.

Further, the total transmittance of the glass substrate and the light diffusion layer is preferably 10% or less in a wavelength region of 310 nm or shorter in order to absorb UV light from light sources and to prevent the deterioration of components such as a diffusion film or a prism sleet that are made of organic materials and disposed in the front side of the light diffusion plate.

Further, in order to improve the contrast of display images and to increase the color purity of light from the light source, the substrate may be colored.

The light diffusion layer 110 is constituted by a matrix and light diffusion fine particles being a light diffusion agent, and the absolute value Δn (hereinafter it may be abbreviated to refractive index difference) of the refractive index difference between the matrix and the light diffusion agent in the visible light region is 0.05 or more and less than 0.5, and the volume fraction (hereinafter it may be abbreviated to volume fraction in the layer) of the light diffusion agent in the light diffusion layer is 30% or more. If the refractive index difference is less than 0.05, the light diffusion performance is insufficient. If it is 0.5 or more, unnecessary diffusion increases and the total light beam transmittance of the light diffusion layer decreases. The absolute value Δn of the refractive index difference is preferably from 0.05 to 0.3. Further, if the volume fraction in the layer is less than 30%, the light diffusion performance is insufficient.

Here, it is also possible to exhibit a desired diffusion property by increasing the film thickness by increasing the number of coating operations, but such an increase of coating operations increases the cost.

Here, the volume fraction in the layer of the light diffusion agent is a value of volume percentage of the light diffusion agent in the layer divided by the total value of the volume percentage of the light diffusion agent and the volume percentage of the matrix in the layer. The volume fraction in the layer is obtainable by observing a cross-section of the light diffusion layer by e.g. a SEM. Here, when a plurality of light diffusion agents are employed, the volume fraction in the layer is the sum of the volume fraction in the layers of the respective light diffusion agents.

Here, in this specification, a matrix means a material forming the layer itself (a portion other than light diffusion fine particles) of the light diffusion layer, and it is specifically a matrix-forming component to be described later, and in some cases, it includes a layer component constituted by a curing agent required for curing the matrix-forming component. Further, the refractive index of a matrix is the refractive index of a layer (cured product) formed by the matrix-forming component, and it is approximately the same as the refractive index of the matrix-forming component contained in a coating liquid for forming a light diffusion layer to be described later.

The matrix-forming component constituting the matrix of the light diffusion layer 110 functions as a binder for the light diffusion agent after a layer to hold the light diffusion agent is formed. Further, the matrix-forming component is a material having an adhesiveness to a substrate after the layer is formed, and is preferably transparent. Further, the matrix-forming component is preferably a material capable of forming a layer by coating, and particularly, it is preferably a crosslinkable coating material curable by e.g. heat or UV rays. Such a matrix-forming component may, for example, be a resin material such as an urethane type resin, a polyester type resin, an acrylic type resin, a styrene type resin, a polycarbonate type resin, a polymethyl pentene type resin, an acrylic/styrene copolymer resin, an epoxy type resin, an olefin type resin or a silicone type resin; a crosslinked product obtainable from a hydrolyzed product of a metal alkoxide; an inorganic material such as a low-melting point glass; or a mixture thereof.

Among these, the matrix-forming component is preferably an urethane resin since it is curable at a low temperature, it is free from cracking due to curing shrinkage even when a thick film having a thickness of a few tens μm is formed, and a film having a high hardness can be obtained. Particularly, it is preferably an urethane resin obtainable by a reaction of a polyester resin and an isocyanate curing agent.

The refractive index of the matrix-forming component is usually from 1.42 to 1.59 when the component is an organic material, and it is usually from 1.45 to 2.7 when the component is an inorganic material. The refractive index of the matrix is approximately equal to the refractive index of the matrix-forming component forming the matrix. The refractive index of the matrix is selected so that the refractive index difference from the light diffusion agent to be described later becomes 0.05 or more and less than 0.5. Here, the refractive index of the matrix may be lower or higher than the refractive index of the light diffusion agent, and it is not particularly limited. Here, when a plurality of light diffusion agents are employed, the refractive index difference is calculated from a formula of [the sum of values “volume fraction in the layer×refractive index difference” of respective light diffusion agents]/[volume fraction in the layer of all light diffusion agents].

The light diffusion agent contained in the light diffusion layer 110 is not particularly limited in the material so long as it comprises transparent fine particles showing little absorption of light in the visible light region and having a particle size of a few microns. The light diffusion agent may, for example, be transparent inorganic oxide fine particles of e.g. silica or alumina; inorganic fine particles such as glass beads; organic fine particles such as transparent polymer beads; or a mixture thereof. The polymer beads may be made of an acrylic type, a styrene type or a silicone type resin. The shape of the light diffusion agent may be a perfect spherical shape or an irregular shape.

The average particle size of the light diffusion agent is preferably from 1 to 20 μm, more preferably from 3 to 20 μm. If it is less than 1 μm, the wavelength dispersion of the refractive index for light tends to occur, and when it exceeds 20 μm, a film showing a coarse brightness distribution in the screen tends to be formed, which is not preferred. Here, the average particle size was measured by a Coulter Counter method. Further, the refractive index of the light diffusion agent changes depending on the material, but it is not particularly limited so long as it satisfies the refractive index difference required in the present invention.

In the present invention, the thickness of the light diffusion layer is preferably from 5 to 100 μm, more preferably from 10 to 100 μm. If the thickness of the light diffusion layer is less than 5 μm, the light diffusion performance becomes insufficient even if the refractive index difference or the volume fraction in the layer is increased, and it is difficult to eliminate a light source image. If the thickness of the light diffusion layer exceeds 100 μm, it becomes difficult to form the layer by a single coating operation and it becomes necessary to carry out an additional coating operation, which increases the cost.

The above light diffusion plate can be formed by coating the substrate with the coating liquid (hereinafter it may be abbreviated to coating liquid) for forming a light diffusion layer in which the matrix-forming component and the light diffusion agent are dispersed, and curing the coating film.

The coating liquid is usually a composition comprising the matrix-forming component and the light diffusion agent dispersed in a liquid, and the dispersion is preferably uniform. Such a matrix-forming component may, for example, be a resin material such as a polyester resin, an acrylic resin, a styrene resin, a polycarbonate resin, a polymethyl pentene resin, an acrylic/styrene copolymer resin, an epoxy resin, an olefin resin or a silicone resin; a crosslinked product obtainable from a hydrolyzed product of a metal alkoxide; an inorganic material such as a low-melting point glass; or a mixture thereof.

Among these, the matrix-forming component preferably comprises at least a polyester resin, particularly a polyester polyol resin, since such a resin forms an urethane bond with an isocyanate type curing agent to be described later, to form a film having high strength and high durability.

Further, its average molecular weight is preferably from 1,000 to 9,000, more preferably from 1,000 to 7,000. If the average molecular weight is less than 1,000, the hardness of the coating film becomes low, and if the average molecular weight exceeds 9,000, the viscosity of the coating liquid becomes too high when it is mixed with the light diffusion agent, and it becomes difficult to form an uniform coating film. Here, the average molecular weight means an weight-averaged molecular weight.

The light diffusion agent may be the above-mentioned transparent inorganic oxide fine particles such as silica or alumina; inorganic fine particles such as glass beads; organic fine particles such as transparent polymer beads; or a mixture thereof. The organic fine particles may be polymer beads. The polymer beads may, for example, be ones made of an acrylic, a styrene or a silicone resin. The shape of the light diffusion agent may be a perfect spherical shape or an irregular shape.

Here, with respect to the matrix-forming component and the light diffusion agent, the in-liquid volume ratio of the light diffusion agent defined as the following formula is preferably 30% or more and the absolute value of the refractive index difference Δn between the matrix-forming component and the light diffusion agent is preferably 0.05 or more and less than 0.5, more preferably 0.05 or more and less than 0.3. If the in-liquid volume ratio of the light diffusion agent is less than 30%, the diffusion performance of the light diffusion plate becomes insufficient. If the absolute value of the refractive index difference Δn between the matrix-forming component and the light diffusion agent is less than 0.05, the light diffusion performance becomes insufficient, and if it is 0.5 or more, the total light beam transmittance of a light diffusion plate formed decreases, which is not preferred.

$$Volume fraction in the liquid ( \% ) = \frac{[ \frac{Mass content of light diffusion agent in coating liquid}{Specific gravity of light diffusion agent} ]}{\begin{matrix}[ \frac{Mass content of light diffusion agent in coating}{Specific gravity of light diffusion agent} ] + \\ [ \frac{Mass content of matrix in coating}{Specific gravity of matrix} ]\end{matrix}} \times 100$$

The coating liquid contains a curing agent for curing the matrix-forming component as the case requires. The curing agent may, specifically for example, be an isocyanate curing agent, an amine (curing agent, an imidazole curing agent or an acid anhydride curing agent.

Among these, an isocyanate curing agent is preferred since it is transparent and reacts with a polyester polyol resin to form a strong urethane bond.

The content of the curing agent is preferably 30 mass % or less, more preferably 20 mass % or less based on the total mass of the coating liquid for forming a light diffusion layer. Such a range is preferred since the properties required for the light diffusion plate are not deteriorated.

Further, the coating liquid may contain other components so long as the objectives of the present invention are not impaired. Such other components include a coupling agent which is a component for improving the adhesion to a substrate, a dispersing agent, a surfactant for improving the wettability to a substrate, a defoaming agent and a leveling agent. Such other components are preferably contained in the coating liquid in an amount of 10 mass % or less; in order not to deteriorate the properties required for a diffusion plate. A solvent to be used for the coating liquid may be appropriately selected from commonly used solvents suitable for coating depending on the material. It is preferably, for example, an alcohol such as methanol, ethanol, n-propanol, isopropanol, n-butanol, isobutanol, sec-butanol or tert-butanol; a polyhydric alcohol such as ethylene glycol; an ether such as ethyl cellosolve, methyl cellosolve, butyl cellosolve or propylene glycol methyl ether; a ketone such as 2,4-pentanedione or diacetone alcohol; a hydrocarbon such as hexane, toluene, xylene or solvent naphtha; an ester such as ethyl lactate or methyl lactate; an amide such as N-methylpyrrolidone; or a sulfur compound such as dimethylsulfoxide or sulfolane.

In the present invention, the method for coating a substrate with the coating liquid for forming a light diffusion layer of the present invention is not particularly limited, and it may be roller coating, hand coating, brush coating, dipping, spin coating, dip coating, screen printing, curtain flow coating, bar coating, die coating, gravure coating, micro-gravure coating, reverse coating, roll coating, flow coating, spray coating or dip coating.

Among these, screen printing is preferred since it enables coating of a large area and enables forming of a thick film by a single coating operation.

In the present invention, the method for drying and curing the coating film formed by the above coating step is not particularly limited, and it may, for example, be a method of leaving the glass substrate coated with the coating liquid for forming the light diffusion layer of the present invention at room temperature to naturally dry the coating film, a method of heating the substrate with the coating film in an oven, or a method of irradiating the coating film with UV rays. Further, these methods may be combined as the case requires. In a case where a curing agent is contained and the curing involves a chemical reaction, heating or UV irradiation is preferably carried out. In a case of drying and curing the coating film by heating, the heating is preferably carried out at a temperature of not too high, and the heating is carried out in the atmospheric air at a low temperature of from 80 to 200° C. for from 5 to 60 minutes.

The backlight unit of the present invention is a backlight unit provided with the light diffusion plate of the present invention. FIG. 2 is a side cross-sectional view schematically showing an example of a preferred embodiment of the backlight unit of the present invention. As shown in FIG. 2, from the backside, a reflective plate 6, light sources 5, a light diffusion plate 1a of the present invention, a diffusion film 2, a prism sheet 3, a brightness-improving film 4 and a liquid crystal panel 7 on the backlight unit thus constituted are arranged in this order. FIG. 2 shows an embodiment wherein a light diffusion layer 110 is provided so as to face to the light sources, but it may be provided so as to face to the viewer.

The light diffusion plate 1a of the present invention functions to diffuse light from the light source 5 to erase a light source image of the light sources to make the brightness distribution in the screen uniform.

The diffusion film 2 and the prism sheet 3 function to condense divergent light from the light diffusion plate on the front face to improve the brightness. The brightness-improving film 4 functions to align the polarization of the light from the light sources to the orientation of the liquid crystal to improve the brightness.

The light sources 5 function to supply light to the liquid crystal panel, and for each of the light sources 5, a CCFL (cold cathode fluorescent light source), a HCFL (hot cathode fluorescent light source), an EEFL (external electrode fluorescent light source), an LED (light emitting diode), an FFL (flat fluorescent light source), etc. is employed.

The reflective plate 6 functions to reflect the light emitted backwardly from the light sources, to utilize the light efficiently.

In the light diffusion plate of the present invention, the volume fraction in the layer and the refractive index difference are controlled to achieve high transmittance and sufficient diffusion performance, and a glass is employed as the substrate to achieve a high rigidity and eliminate thermal deformation and yellowing, whereby the light diffusion plate is readily applicable to a large sized or a thin backlight unit. For this reason, it is suitable as a diffusion plate for a direct type backlight unit.

### EXAMPLES

Now, the present invention will be specifically described with reference to Examples and Comparative Examples, but it is a matter of course that the present invention is not limited to these examples.

### Example 1

### Preparation of Coating Liquid A

50 g of a polyester resin (Vyron 220 manufactured by Toyobo Co., Ltd.; specific gravity: 1.26; average molecular weight: 5,000) and 50 g of a diluted solvent (G-004 solvent, manufactured by Teikoku Printing Inks Mfg. Co., Ltd.) were mixed and stirred to prepare as a matrix-forming component a polyester resin solution “a” containing a solid state content of 50 mass %.

100 g of the polyester resin solution “a”, 8.1 g of an isocyanate type curing agent (210 curing agent manufactured by Teikoku Printing Inks Mfg. Co., Ltd.) as a curing agent, 1.1 g of an epoxy type silane coupling agent (KBM-403 manufactured by Shin-Etsu Chemical Co., Ltd.), 1 g of a defoaming agent (manufactured by Teikoku Printing Inks Mfg. Co., Ltd.), 0.11 g of dibutyltin dilaurate (DBTDL) as a curing agent, and 66.7 g of benzoguanamine-formaldehyde-condensed resin fine particles (Epostar M05, manufactured by Nippon Shokubai Co., Ltd.; specific gravity: 1.4; average particle size: 5 μm; refractive index: 1.66) as a light diffusion agent, were mixed and stirred to obtain a coating liquid A.

### Preparation of Light Diffusion Plate A

A surface of a 30 cm square glass plate [soda lime silicate glass; non-tempered glass; thickness: 1.8 mm; visible light transmittance (JIS K7361-1 (year 1997)): 92%] was coated with the coating liquid A by a screen printing method (mesh material: polyester; mesh #: 120 mesh) to form a coating film, and it was dried in the atmospheric air in a drying machine at 180° C. for 10 minutes to be cured to form a light diffusion layer thereby to form a light diffusion plate A. The thickness of the light diffusion layer of the light diffusion plate A was 25 μm.

### Example 2

A light diffusion plate B was obtained in the same manner as Example 1 except that the light diffusion agent of Example 1 was changed to 133.3 g of alumina fine particles [CB-A05S manufactured by Showa Denko K.K.; specific gravity: 3.98; average particle size: 3 μm; refractive index: 1.76]. The thickness of the light diffusion layer of the light diffusion plate B was 17 μm.

### Comparative Example 1

A light diffusion plate C was obtained in the same manner as Example 1 except that the amount of the light diffusion agent of Example 1 was changed to 22 g. The thickness of the light diffusion layer of the light diffusion plate C was 20 μm.

### Comparative Example 2

A light diffusion plate D was obtained in the same manner as Example 1 except that the light diffusion agent of Example 1 was changed to 5.6 g of TiO₂ fine particles (Tipaque CR-90 manufactured by Ishihara Sangyo Kaisha Ltd.; specific gravity: 3.8; average particle size: 0.3 μm; refractive index: 2.7). The thickness of the light diffusion layer of the light diffusion plate D was 12 μm.

### Comparative Example 3

A light diffusion plate E was obtained in the same manner as Comparative Example 2 except that the amount of the TiO₂ fine particles of Comparative Example 2 was changed to 11.1 g. The thickness of the light diffusion layer of the light diffusion plate E was 12 μm.

### Comparative Example 4

A light diffusion plate F was obtained in the same manner as Example 1 except that the light diffusion agent of Example 1 was changed to 55.6 g of polystyrene fine particles (SBX-8 manufactured by Sekisui Plastics Co., Ltd.; specific gravity: 1.06; average particle size: 8 μm; refractive index: 1.59). The thickness of the light diffusion layer of the light diffusion plate F was 20 μm.

### Comparative Example 5

A coating liquid E was prepared in the same manner as Example 1 except that the polyester resin of Example 1 was changed to Vyron 200 manufactured by Toyobo Co., Ltd. (specific gravity: 1.26; average molecular weight: 17,000), but the viscosity of the coating liquid was too high, and uniform coating was not possible.

Performances of the light diffusion plates prepared were evaluated by the method described below Table 1 shows the results.

### Evaluation

(1) Diffusion Performance

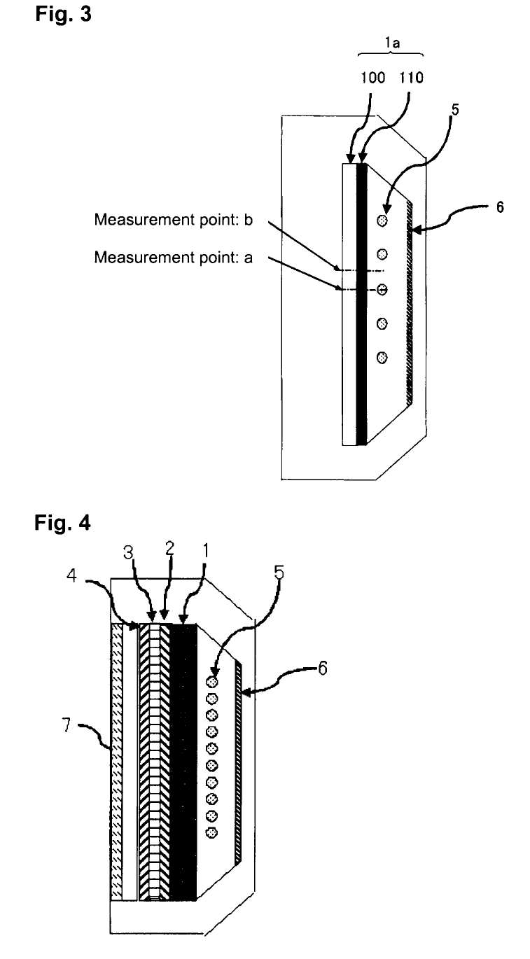

As shown in FIG. 3, in a state that each light diffusion plate was built in a backlight unit, the brightness of every portion of the plate was measured by a CCD type brightness meter (Eysscale4 manufactured by I•System Corporation) to obtain an in-screen distribution, and the brightness of a portion of the light diffusion plate corresponding to the position of a light source (measurement point “a” in FIG. 4) was designated as La, and the brightness of a portion of the diffusion plate corresponding to an intermediate portion between light sources (measurement point “b” in FIG. 4) was designated as Lb, and a value of Lb/La was designated as the diffusion performance. In the present invention, in order to qualify an in-screen diffusion performance as uniform, it is necessary that a condition of 0.97<Lb/La<1.03 is satisfied, preferably a condition of 0.98<Lb/La<1.02 is satisfied. Table 1 shows the results.

(2) Transmittance

In a case of forming a light diffusion layer on a soda lime silicate glass (1.8 mm thick) having a transmittance of 92% (JIS K7361-1 (year 1997)), the transmittance of the diffusion plate was measured according to JIS K7361-1 (year 1997). In the present invention, in order to qualify a transmittance as high, it is necessary that the transmittance is 60% or more, preferably 70% or more. Table 1 shows the results. Here, the transmittance was measured in the direction in which light is incident into the surface of each glass substrate on which the diffusion layer was formed.

(3) Haze

The haze of each diffusion plate was measured according to JIS K7136 (year 2000). In the present invention, the haze is preferably 98% or more, more preferably 99% or more.

(4) Refractive Index

The refractive index of each matrix was measured by employing a prism coupler method (Model 2010 manufactured by Metricon Corporation) at a measurement wavelength of 633 nm. Table, 1 shows the results.

(5) Overall Evaluation

The light diffusion plate of the present invention, is required that the above-mentioned (1) diffusion performance and (2) transmittance, are satisfied at the same time.

TABLE 1

| | | | Example | | Comparative Example | | | | |
|---|---|---|---|---|---|---|---|---|---|
| | | | 1 | 2 | 1 | 2 | 3 | 4 | 5 |
| Coating | | | A | B | C | D | E | F | G |
| liquid (mass | Matrix | Polyester resin | 50 | 50 | 50 | 50 | 50 | 50 | |
| parts) | | (molecular weight: 5,000) | | | | | | | |
| | | Polyester resin | | | | | | | 50 |
| | | (molecular weight: 17,000) | | | | | | | |
| | Diluted solution | G-004 solvent | 50 | 50 | 50 | 50 | 50 | 50 | 50 |
| | of matrix | | | | | | | | |
| | Other component than | Isocyanate type curing agent | 8.1 | 8.1 | 8.1 | 8.1 | 8.1 | 8.1 | 8.1 |
| | matrix-forming | Silane coupling agent | 1.1 | 1.1 | 1.1 | 1.1 | 1.1 | 1.1 | 1.1 |
| | components | Curing catalyst | 0.11 | 0.11 | 0.11 | 0.11 | 0.11 | 0.11 | 0.11 |
| | | Defoaming agent | 1 | 1 | 1 | 1 | 1 | 1 | 1 |
| | Light diffusion agent | Benzoguanamine | 66.7 | | 22 | | | | 66.7 |
| | | formaldehyde condensed | | | | | | | |
| | | fine particles (n = 1.66) | | | | | | | |
| | | Al₂0₃ fine particles (n = 1.76) | | 133.3 | | | | | |
| | | TiO₂ fine particles (n = 2.7) | | | | 5.6 | 11.1 | | |
| | | Polystyrene fine particles | | | | | | 55.6 | |
| | | (n = 1.59) | | | | | | | |
| Film | | Refractive index difference | 0.11 | 0.21 | 0.11 | 1.21 | 1.21 | 0.03 | Viscosity |
| properties | | Fine particle volume ratio | 49 | 44 | 24 | 2.9 | 5.6 | 52 | was too |
| | | Film thickness (μm) | 25 | 17 | 20 | 12 | 12 | 20 | high for |
| Evaluation | Evaluation of diffusion | Diffusion performance: (in- | 0.986 | 0.981 | 0.764 | 0.874 | 0.979 | 0.478 | coating |
| | plate alone | screen brightness uniformity) | | | | | | | |
| | | Transmittance: including glass | 69.4 | 72.1 | 82.9 | 53.9 | 42.3 | 96.5 | |
| | | (transmittance: 92%) | | | | | | | |
| | | Haze (%) | 99.4 | 99.2 | 93.8 | 91.9 | 98.7 | 89.7 | |

As shown in Table 1, Examples 1 and 2 achieve both good light diffusion performance and high transmittance. Further, the light diffusion layers of Examples 1 and 2, which were each coated by a single coating step of a screen printing method, had sufficient light diffusion performances.

On the other hand, in Comparative Example 1, since the fine particle volume ratio is too low, the light diffusion performance is poor. Further, in Comparative Examples 2 and 3, since the refractive index differences are too large, it is not possible to satisfy both of the light diffusion performance and the brightness. In Comparative Example 4, since the refractive index difference is too small, the light diffusion performance is poor. In Comparative Example 5, since the average molecular weight of the polyester resin is too high, the viscosity of the coating liquid becomes too high and uniform coating cannot be achieved.

Next, each of the light diffusion plates of Examples and Comparative Examples was attached to a backlight unit for comparison. Here, the brightness of the backlight unit to which each of the light diffusion plates was attached is preferably 9,500 or more (cd/m²). The evaluation was made with respect to the front brightness and the uniformity in the screen of the backlight unit. Specifically, the front brightness was obtained by measuring the brightness of every portion in the entire screen by using a CCD type brightness meter (Eysscale4 manufactured by I•System Corporation) and the average of measurement results was designated as a front brightness. It was compared to the brightness of a commercial product. Comparison of uniformity in the screen was carried out by visually observing the entire screen by an observer at a distance of 50 cm from the front center of the backlight unit, and the results were designated as ∘ when the light source shape was sufficiently diffused to be unseeable, and the results were designated x when it was seeable. Table 2 shows the results.

TABLE 2

| Backlight | Example | | Comparative Example | | | |
|---|---|---|---|---|---|---|
| unit evaluation | 1 | 2 | 1 | 2 | 3 | 4 |
| Front brightness | 10100 | 9900 | 10700 | 8800 | 7700 | 10500 |
| (cd/m²) | | | | | | |
| Uniformity in | ◯ | ◯ | X | X | ◯ | X |
| the screen | | | | | | |

The backlight units of Examples 1 and 2 employing the light diffusion plates of the present invention show high front brightness and good uniformity in the screen, and satisfy both the brightness and the in-screen distribution at the same time. With respect to Comparative Examples, the backlight units of Comparative Examples 1, 2 and 4 show high brightness but poor in-screen distribution, while the backlight unit of Comparative Example 3 shows a good in-screen distribution but a low brightness. Accordingly, the backlight units in these Comparative Examples fail to satisfy the brightness and the in-screen distribution at the same time. Further, since the light diffusion plate of the present invention employs a glass substrate, the light diffusion plate has a smaller warp and deflection than a backlight unit employing a resin substrate having the same thickness. Further, since the light diffusion plate has no thermal deformation, yellowing, or absorption/reemission of moisture from itself, which are problems unique to a resin light diffusion plate, it is possible to reduce the distance from light sources to the light diffusion plate.

### INDUSTRIAL APPLICABILITY

The light diffusion plate of the present invention can satisfy both high transmittance and sufficient diffusion performance. Accordingly, it has a high brightness even if the amount of light from the light sources of a backlight unit is low, and it can uniformly diffuse light even if the number of the light sources in the backlight unit is small, whereby it is possible to increase the size, decrease the thickness and decrease the weight of the backlight unit. Further, the light diffusion plate employs a low cost glass substrate and a thin light diffusion layer, and the light diffusion plate having a desired diffusion performance can be produced by a single cycle of coating and drying, whereby the light diffusion plate is excellent in the cost performance.

The entire disclosure of Japanese Patent Application No. 2007-012677 filed on Jan. 23, 2007 including specification, claims, drawings and summary is incorporated herein by reference in its entirety.

1. A light diffusion plate comprising a glass substrate and a light diffusion layer formed on the glass substrate, wherein the light diffusion layer comprises a matrix and a light diffusion agent, the absolute value Δn of the refractive index difference between the matrix and the light diffusion agent is 0.05 or more and less than 0.5, and the volume fraction of the light diffusion agent in the light diffusion layer is 30% or more.

2. The light diffusion plate according to claim 1, wherein the thickness of the light diffusion layer is from 5 to 100 μm.

3. The light diffusion plate according to claim 1, wherein the matrix contains an urethane type resin.

4. The light diffusion plate according to claim 1, wherein the glass substrate is made of a soda lime silicate glass.

5. A direct type backlight unit employing the light diffusion plate as defined in claim 1.

6. The direct type backlight unit according to claim 5, wherein the brightness of the front side of the direct type backlight unit is 9,500 cd/m² or more

7. A coating liquid for forming a light diffusion layer containing a matrix-forming component and a light diffusion agent, wherein the absolute value Δn of the refractive index difference between a matrix formed from the matrix-forming component and the light diffusion agent is 0.05 or more and less than 0.5, and the matrix-forming component is a polyester polyol type resin having an average molecular weight of from 1,000 to 9,000, and a volume fraction in the liquid of the light diffusion agent defined by the following formula is 30% or more:
$$Volume fraction in the liquid ( \% ) = \frac{[ \frac{Mass content of light diffusion agent in coating liquid}{Specific gravity of light diffusion agent} ]}{\begin{matrix}[ \frac{Mass content of light diffusion agent in coating}{Specific gravity of light diffusion agent} ] + \\ [ \frac{Mass content of matrix in coating}{Specific gravity of matrix} ]\end{matrix}} \times 100$$

8. The coating liquid for forming a light diffusion layer according to claim 7 which contains an isocyanate type curing agent.

9. A process for producing a light diffusion plate having a glass substrate and a light diffusion layer formed on the glass substrate, which comprises a coating step of coating the glass substrate with the coating liquid for forming a light diffusion layer as defined in claim 7 so as to form a coating film, and a forming step of drying and curing the coating film to form the light diffusion layer.
